(19) United States
(12) Patent Application Publication
(10) Pub. No.: US 2021/0067507 A1
(43) Pub. Date: Mar. 4, 2021

(54) INFORMATION PROCESSING APPARATUS AND PROCESSING METHOD FOR THE SAME

(71) Applicant: SONY CORPORATION, TOKYO (JP)

(72) Inventor: SHINYA MARUYAMA, KANAGAWA (JP)

(21) Appl. No.: 16/960,485

(22) PCT Filed: Oct. 26, 2018
(86) PCT No.: PCT/JP2018/039864

§ 371 Date: Jul. 7, 2020

(30) Foreign Application Priority Data
Jan. 22, 2018 (JP) 2018-007789

(51) Int. Cl. H04L 29/06

(52) U.S. Cl. CPC H04L 63/0823; G06Q 30/0185; H04L 63/0884

(57) ABSTRACT

The purpose of the present invention is to identify a business operator without performing an update after a device is installed even in the case where the business operator of the device has changed. The information processing apparatus is provided with a reception unit and an identification unit. The reception unit receives sensing information addressed to a virtual business operator from a sensing device (IoT device) which measures a surrounding environment. The identification unit identifies actual business operator identification information of an actual business operator corresponding to the sensing information by making an inquiry to a storage unit. The storage unit stores virtual business operator identification information identifying the virtual business operator and actual business operator identification information identifying the actual business operator, which are associated with each other.

### TECHNICAL FIELD

The present technology relates to an information processing apparatus. To be more specific, the present invention relates to an information processing apparatus for determining a transmission destination of information from a device, and a processing method thereof.

### BACKGROUND ART

With the advent of the IoT (Internet of Things) era, IoT devices having a wireless communication function are rapidly spreading. Some IoT devices are difficult to be collected and some are not worth the collection cost depending on the installation location. In some cases, the device may be transferred to another business operator without collecting the device. In the case where the IoT device has a business operator's authentication function, it is necessary to update the device to recognize the business operator to which the device has been transferred, but most of the device authentication is based on a certificate embedded at the time of manufacture due to the security characteristics, and thus, updating the device after installation is difficult. Therefore, an apparatus has been proposed in which a plurality of types of electronic certificates is collectively managed and authentication is performed by using a designated electronic certificate (for example, see PTL 1).

### CITATION LIST

### Patent Literature

[PTL 1]

JP 2005-020536A

### SUMMARY

### Technical Problem

In the above-described conventional technology, authentication can be performed by designating one from a plurality of types of electronic certificates managed collectively. However, there is a risk that the capacity of the storage area will increase if all the assumed electronic certificates are registered, and there is a problem that the technology cannot cope with the case where the device is transferred to a business operator that was not assumed before the installation.

The present technology has been created in view of such a situation, and an object thereof is to identify a business operator of the device without updating after installing the device even in the case where there is a change in the business operator.

### Solution to Problem

The present technology has been made to solve the above-described problem, and the first aspect thereof is an information processing apparatus including a reception unit that receives sensing information addressed to a virtual business operator from a sensing device that measures a surrounding environment, and an identification unit that makes an inquiry to a storage unit that stores virtual business operator identification information for identifying the virtual business operator and actual business operator identification information for identifying an actual business operator with the pieces of information associated with each other, and that identifies the actual business operator identification information corresponding to the sensing information, and a processing method thereof. This brings about the effect of identifying the actual business operator from the virtual business operator without updating the sensing device.

Further, in the first aspect, the identification unit may transmit the sensing information on the basis of the identified actual business operator identification information. This brings about an effect of mediating transmission to the actual business operator.

Further, in the first aspect, the information processing apparatus may further include an authentication unit that authenticates the virtual business operator by using key information unique to the sensing device. The reception unit may receive the key information together with the sensing information, and then the identification unit may transmit the sensing information on the basis of the identified actual business operator identification information in the case where the authentication by the authentication unit is successful. This brings about an effect of mediating the transmission to the actual business operator when the authentication is successful.

Furthermore, in the first aspect, the identification unit may transmit the identified actual business operator identification information to the sensing device. This brings about an effect of providing information necessary for transmission to the actual business operator.

Besides, in the first aspect, the information processing apparatus may further include an authentication unit for authenticating the virtual business operator by using key information unique to the sensing device. The reception unit may receive the key information, and then the identification unit may transmit the identified actual business operator identification information and authentication success information to the sensing device in the case where the authentication by the authentication unit is successful, and further the authentication unit may authenticate the sensing information when receiving the authentication success information together with the sensing information from the sensing device. This provides an effect of providing information necessary for transmission to an actual business operator at the time of successful authentication.

In addition, in the first aspect, the actual business operator identification information may include a URL address of the actual business operator. This brings about an effect of accessing a server or the like operated by the actual business operator.

Further, in the first aspect, the information processing apparatus may further include a switching unit that changes over from the actual business operator identification information stored in the storage unit in association with the virtual business operator identification information to another business operator identification information for identifying another actual business operator. This brings about an effect of switching the business operators without updating the sensing device.

Furthermore, in the first aspect, in response to a request from the other business operator, the switching unit may make a switch to the other business operator identification information. This brings about an effect of switching the business operators in response to a request from the business operator to which the device is transferred.

Moreover, in the first aspect, the switching unit may make a switch to the other business operator identification information in accordance with the cooperation of the actual business operator and the other business operator. This brings about an effect of switching the business operators according to the cooperation of the operators concerning the transfer.

Besides, in the first aspect, the switching unit may change the actual business operator identification information stored in the storage unit in association with the virtual business operator identification information to make a switch to a revoked state. This brings about an effect of invalidating the sensing device without updating.

In addition, in the first aspect, the information processing apparatus may further include the storage unit. This brings about an effect of collectively managing the business operator identification information.

### Advantageous Effect of Invention

According to the present technology, an excellent effect can be achieved such that the business operator can be identified without updating after installing the device even in the case where the business operator of the device is changed. Note that the effect is not necessarily limited to the effects described here, and may be any of the effects described in the present disclosure.

### BRIEF DESCRIPTION OF DRAWINGS

FIG. 1 is a diagram illustrating an example of an overall configuration of a system based on a trust proxy server model according to an embodiment of the present technology.

FIG. 2 is a diagram illustrating a first configuration example of a trust proxy server 200 according to the embodiment of the present technology.

FIG. 3 is a diagram illustrating a second configuration example of the trust proxy server 200 according to the embodiment of the present technology.

FIG. 4 is a sequence diagram illustrating an example of a processing flow before operation according to the embodiment of the present technology.

FIG. 5 is a sequence diagram illustrating an example of a processing flow during operation according to the embodiment of the present technology.

FIG. 6 is a sequence diagram illustrating a first example of a flow of a process accompanying the transfer according to the embodiment of the present technology.

FIG. 7 is a sequence diagram illustrating a second example of a flow of a process accompanying the transfer according to the embodiment of the present technology.

FIG. 8 is a sequence diagram illustrating a third example of a flow of a process accompanying the transfer according to the embodiment of the present technology.

FIG. 9 is a diagram illustrating an example of a state in which the binding destination of a virtual business operator X has been changed from a business operator A to a business operator B in the embodiment of the present technology.

FIG. 10 is a diagram illustrating an example of an overall configuration of a system based on a trust client server model according to the embodiment of the present technology.

FIG. 11 is a diagram illustrating a first example of a device manufacturing flow according to the embodiment of the present technology.

FIG. 12 is a diagram illustrating a second example of the device manufacturing flow according to the embodiment of the present technology.

FIG. 13 is a diagram illustrating an example of a message transmitted from a device 100 according to the embodiment of the present technology.

FIG. 14 is a diagram illustrating an example of revoking the binding of the device 100 according to the embodiment of the present technology.

FIG. 15 is a diagram illustrating an example of a case where the binding of the device 100 to the virtual business operator X is changed to the binding to a collection operator C in the embodiment of the present technology.

### DESCRIPTION OF EMBODIMENT

Hereinafter, a mode for implementing the present technology (hereinafter, referred to as an embodiment) will be described. The description will be made in the following order.

1. System Configuration (Trust Proxy Server Model)

2. Operation

3. Modification (Trust Client Server Model)

4. Manufacturing of Device

5. Revocation of Device

6. Collection of Device

### <1. System Configuration>

### [Overall Configuration]

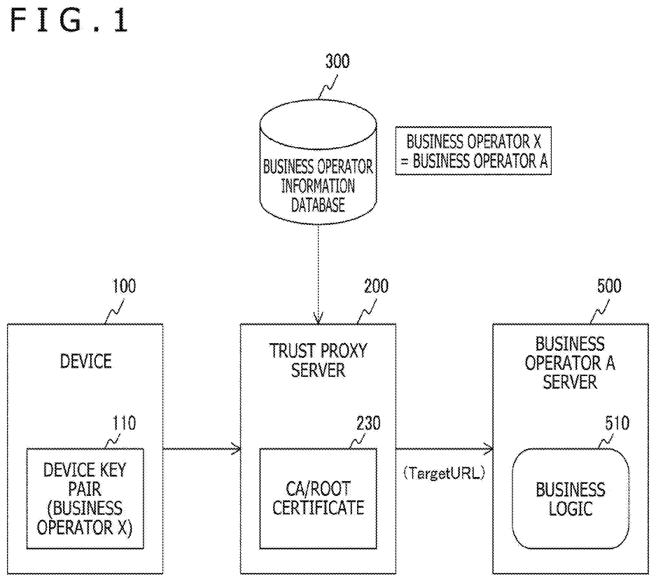

FIG. 1 is a diagram illustrating an example of an overall configuration of a system based on a trust proxy server model according to an embodiment of the present technology.

In the system, it is assumed that a business operator A performs a business by using information transmitted from a device 100. On the other hand, as a management entity of a device key pair of the device 100, a trust business operator which is a third party different from the business operator A is assumed. The system includes the device 100, a trust proxy server 200, a business operator information database 300, and a business operator A server 500.

The device 100 is a sensing device (IoT device) that measures the surrounding environment and transmits sensing information by wireless communication. One or more devices 100 are installed, and the sensing information is finally received by the business operator A. However, a device key pair 110 held by the device 100 is not the key of the business operator A but the key of a virtual business operator X. In other words, the subjective operator (Subject) column of the public key certificate of a device unique key includes information for identifying the virtual business operator X. The device key pair 110 of the virtual business operator X is written in a secure storage and managed by the trust business operator. Therefore, the business operator A cannot access the device key pair 110.

The business operator information database 300 is a database that stores information that associates the virtual business operator X with the business operator A. To be specific, the business operator information database 300 stores virtual business operator identification information for identifying the virtual business operator X in the subjective operator (Subject) column of the public key certificate of the device 100, and business operator A identification information for identifying the business operator A with the pieces of information in association with each other. As a result, the device certificate is bound to the business operator A. Incidentally, the business operator information database 300 is an example of a storage unit described in the claims.

The trust proxy server 200 is a proxy server managed by a trust business operator. The trust proxy server 200 stores a CA/root certificate 230 as a public key set for verifying a public key certificate of a device unique key. The CA/root certificate 230 stores a two-stage CA (Certification Authority) certificate of an intermediate station and a root, assuming a three-stage trust chain of PKI (Public Key Infrastructure).

When transmitting the sensing information, the device 100 calculates a signature by using the secret key of the device key pair 110, and transmits the signature value together with the public key of the device key pair 110. The trust proxy server 200 verifies the transmitted public key with the CA/root certificate 230, and confirms that the key belongs to the device of the virtual business operator X. In addition, the signature is verified using the verified public key, and it is confirmed that the signature has not been falsified. After confirming these, the trust proxy server 200 makes an inquiry to the business operator information database 300 to identify the business operator A identification information of the actual business operator A corresponding to the sensing information. In such an example, the trust proxy server 200 acquires the URL (Uniform Resource Locator) address of the business operator A server 500 operated by the business operator A, and transmits the sensing information to the business operator A server 500. Incidentally, the trust proxy server 200 is an example of an information processing apparatus described in the claims.

The business operator A server 500 is a server operated by the business operator A. The business operator A server 500 receives the sensing information, and performs processing such as accumulating and analyzing data of the sensing result by a business logic 510.

### [Trust Proxy Server]

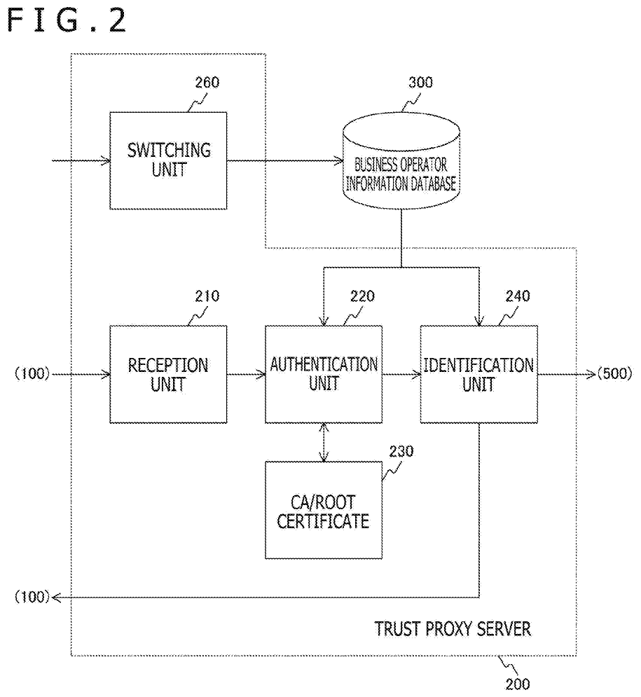

FIG. 2 is a diagram illustrating a first configuration example of the trust proxy server 200 according to the embodiment of the present technology.

The trust proxy server 200 includes a reception unit 210, an authentication unit 220, the CA/root certificate 230, an identification unit 240, and a switching unit 260.

The reception unit 210 receives messages from the device 100. The messages from the device 100 include sensing information, a signature using the secret key of the device key pair 110, and the public key of the device key pair 110. The messages are supplied to the authentication unit 220.

The authentication unit 220 authenticates messages from the device 100. That is, the authentication unit 220 verifies the public key transmitted from the device 100 with the CA/root certificate 230, and confirms that the public key belongs to the device of the virtual business operator X. In addition, the authentication unit 220 verifies the signature by using the verified public key, and confirms that the signature has not been falsified. When these are confirmed, the authentication unit 220 informs the identification unit 240 to that effect.

The identification unit 240 identifies the business operator A identification information of the actual business operator A corresponding to the sensing information. The identification unit 240 receives the virtual business operator identification information of the virtual business operator X from the authentication unit 220, and makes an inquiry to the business operator information database 300 by using the information. The business operator information database 300 supplies the business operator A identification information stored in association with the virtual business operator identification information of the virtual business operator X to the identification unit 240. Thereby, the identification unit 240 can identify the business operator A identification information of the business operator A.

In the trust proxy server 200, the identification unit 240 that has identified the business operator A identification information obtains the URL address of the business operator A server 500 operated by the business operator A and transmits the sensing information to the business operator A server 500. Note that the basic structure is similar to a trust server 201 to be described later, but in such a case, the identification unit 240 transmits the business operator A identification information to the device 100.

The switching unit 260 switches the business operators. In other words, the switching unit 260 changes the business operator identification information stored in the business operator information database 300 in association with the virtual business operator identification information of the virtual business operator X. Thereby, the business operator bound thereto can be switched.

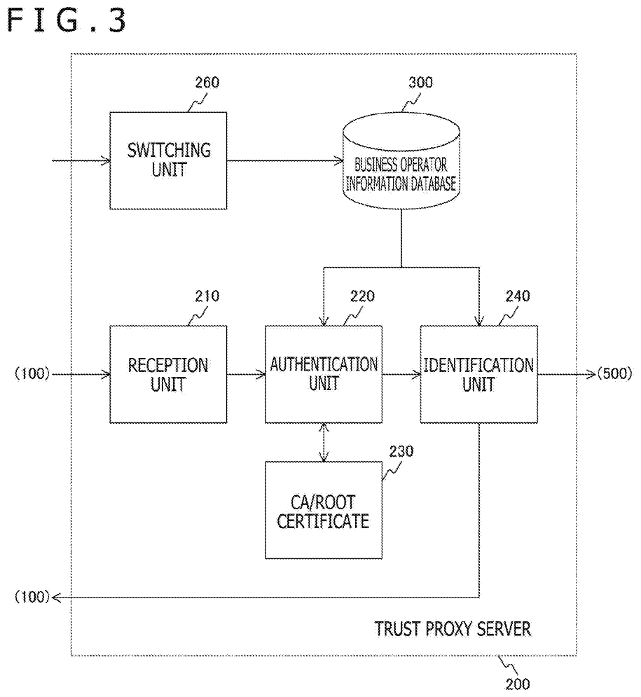

FIG. 3 is a diagram illustrating a second configuration example of the trust proxy server 200 according to the embodiment of the present technology.

In the above-described first configuration example of the trust proxy server 200, although the business operator information database 300 is arranged outside the trust proxy server 200, the internal memory and the like of the trust proxy server 200 stores the business operator information database 300 in the second configuration example. The other points are similar to those in the above-described first configuration example.

### <2. Operation>

### [Before Operation]

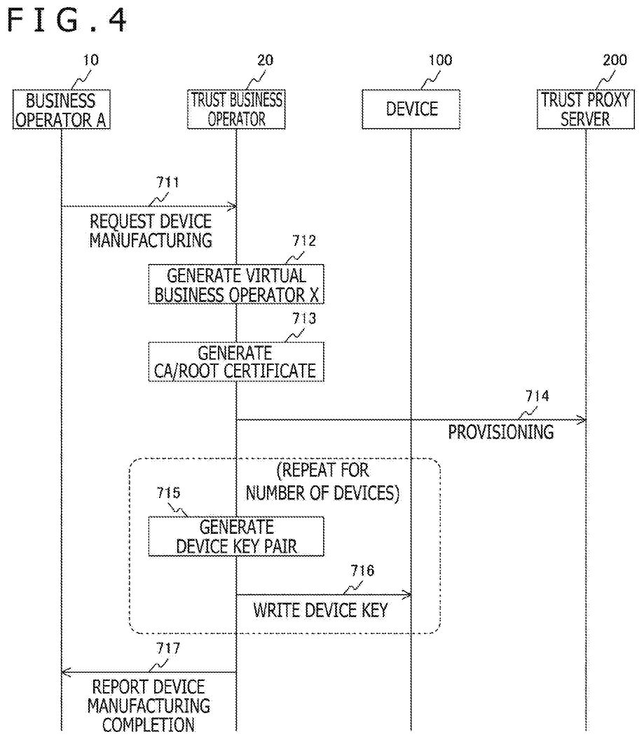

FIG. 4 is a sequence diagram illustrating an example of a processing flow before operation according to the embodiment of the present technology.

A business operator A 10 that conducts business using the device 100 makes a device manufacturing request to a trust business operator 20 (711). In response to the device manufacturing request, the trust business operator 20 generates a virtual business operator X (712). That is, a public key certificate including information for identifying the virtual business operator X in the subjective operator (Subject) column is created. Further, the trust business operator 20 generates a CA/root certificate for authenticating the device 100 (713).

Then, the trust business operator 20 performs provisioning for the trust proxy server 200 for using the device 100 (714). That is, the trust business operator 20 makes provision so as to bind the business operator A to the virtual business operator X, and stores the generated CA/root certificate as the CA/root certificate 230.

Then, the trust business operator 20 generates a device key pair (715), and writes the device key pair into the device 100 as a device key pair 110 (716). The operations (715, 716) are repeated for the number of the devices 100.

When the processes are completed, the trust business operator 20 reports the completion of device manufacturing to the business operator A 10 (717).

### [During Operation]

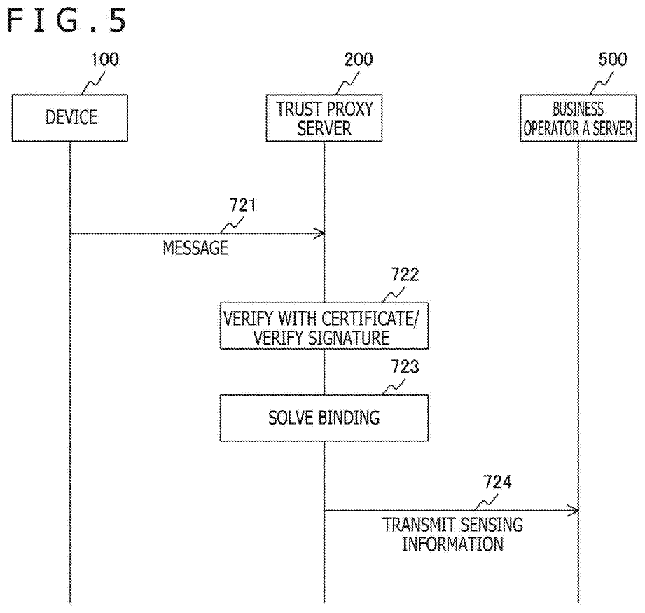

FIG. 5 is a sequence diagram illustrating an example of a processing flow during operation according to the embodiment of the present technology.

The installed device 100 transmits messages at a predetermined frequency (721). The messages include sensing information, a signature using the secret key of the device key pair 110, and the public key of the device key pair 110.

The trust proxy server 200 that has received the message from the device 100 performs authentication (722). That is, the public key transmitted from the device 100 is verified with the CA/root certificate 230 to confirm that the public key belongs to the device of the virtual business operator X. In addition, the signature is verified by using the verified public key, and it is confirmed that the signature has not been falsified.

When these are confirmed, the trust proxy server 200 solves the binding of the virtual business operator X (723). That is, the trust proxy server 200 makes an inquiry to the business operator information database 300 and identifies the business operator A identification information of the actual business operator A corresponding to the sensing information.

The trust proxy server 200 that has identified the business operator A identification information transmits the sensing information on the basis of the business operator A identification information (724). For example, if the business operator A identification information is the URL address of the business operator A server 500, the sensing information is transmitted to the business operator A server 500 by using the URL address.

Thereafter, the processing is performed in the business logic 510 of the business operator A server 500. At that time, a response may be returned to the device 100 as needed. For example, it is conceivable that when recognition processing is performed by an inference engine in the business logic 510, the device 100 may be notified of the recognition result. In addition, in order to adjust the frequency at which the sensing information is transmitted from the device 100, a case may be considered in which the business operator A server 500 gives an instruction using the response.

### [Transfer]

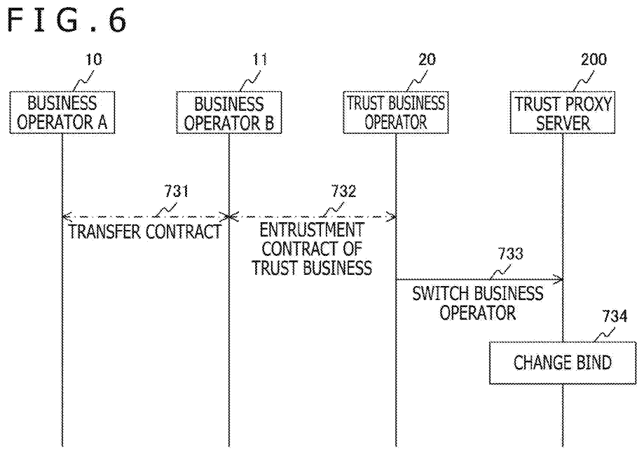

FIG. 6 is a sequence diagram illustrating a first example of a flow of a process accompanying the transfer according to the embodiment of the present technology. The first example is an example in which the trust business operator 20 switches the business operators on the basis of a contract between the business operators.

It is assumed that a contract of business transfer from the business operator A 10 to a business operator B 11 is made between the business operator A 10 and the business operator B (731), and an entrustment contract regarding the trust business is made between the business operator B 11 and the trust business operator 20 (732). According to the contract, the trust business operator 20 performs an operation of switching the business operator from the business operator A 10 to the business operator B 11 (733). Thereby, the binding destination of the virtual business operator X in the trust proxy server 200 is changed from the business operator A 10 to the business operator B 11 (734). In practice, the information stored in the business operator information database 300 in association with the virtual business operator identification information of the virtual business operator X is changed by the switching unit 260 from the business operator A identification information to the business operator B identification information.

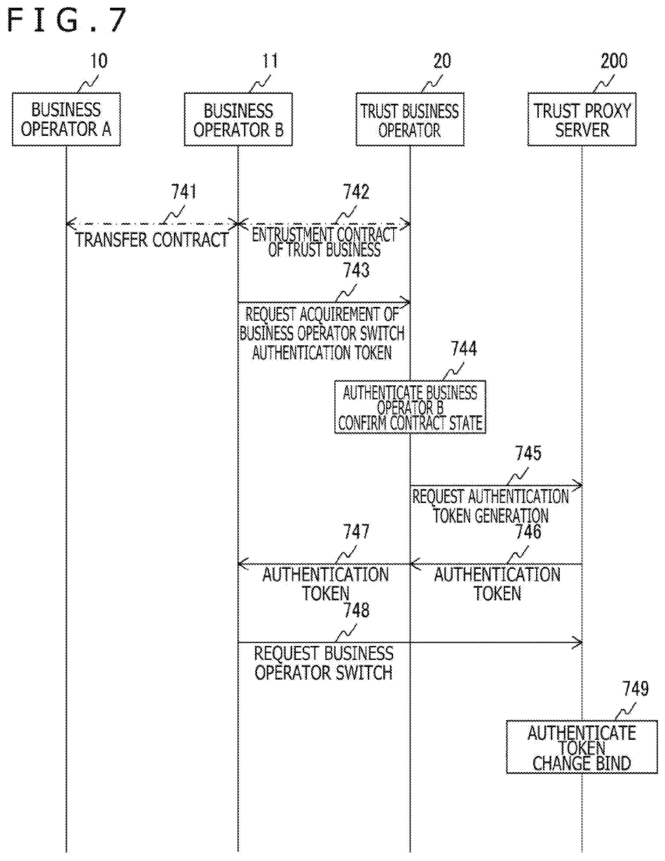

FIG. 7 is a sequence diagram illustrating a second example of a flow of a process accompanying the transfer according to the embodiment of the present technology. The second example is an example in which the business operator B 11 requests the business operator switching on the basis of a contract between the business operators.

The contract of business transfer from the business operator A 10 to the business operator B 11 between the business operator A 10 and the business operator B 11 (741), and an entrustment contract regarding a trust business between the business operator B 11 and the trust business operator 20 (742) are assumed similarly to the first example described above.

The business operator B 11 requests an authentication token for switching business operators from the trust business operator 20 (743). The trust business operator 20 authenticates the business operator B 11 and confirms the contract information (744). As a result, if there is no problem, the switching of the business operators is permitted, and the trust proxy server 200 is requested to generate an authentication token (745).

In response to the generation request of a authentication token, the trust proxy server 200 generates an authentication token (746). The trust business operator 20 transmits the generated authentication token to the business operator B 11 (747).

The business operator B 11 that has received the authentication token transmits a business operator switching request for switching the operator to the business operator B 11 together with the authentication token to the trust proxy server 200 (748). The trust proxy server 200 that has received the business operator switching request confirms the authentication token from the business operator B 11, and if there is no problem, changes the binding destination of the virtual business operator X to the business operator B 11 (749).

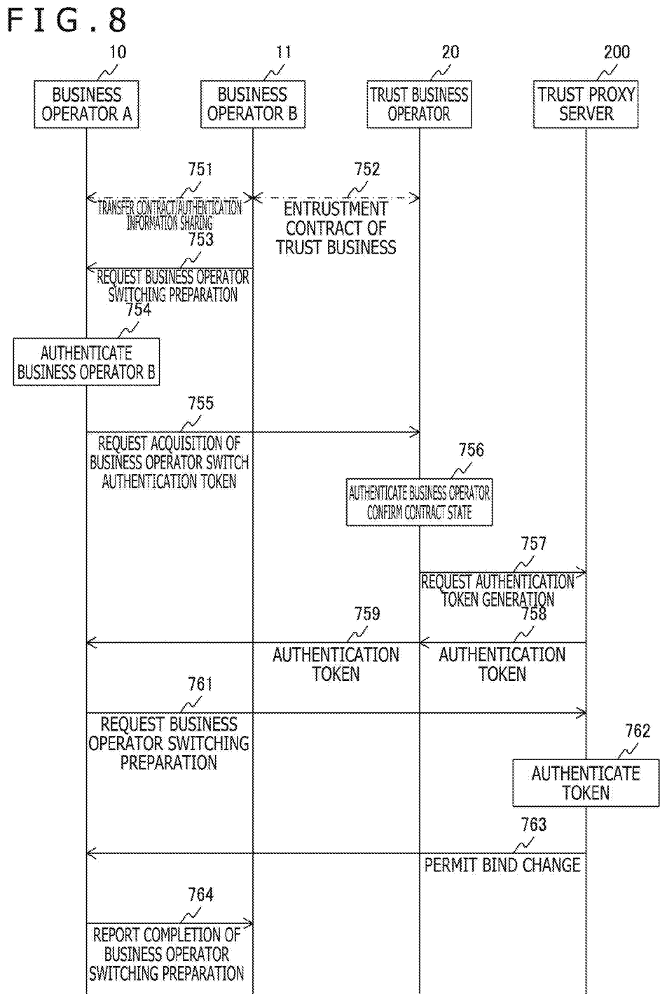

FIG. 8 is a sequence diagram illustrating a third example of a flow of a process accompanying the transfer according to the embodiment of the present technology. The third example is an example in which the business operators A 10 and B 11 cooperate to switch the business operators on the basis of a contract between the business operators.

A contract of the business transfer from the business operator A 10 to the business operator B 11 between the business operator A 10 and the business operator B 11 (751), and an entrustment contract regarding a trust business between the business operator B 11 and the trust business operator 20 (752) are assumed similarly to the first example described above. However, it is necessary to share the authentication information between the business operator A 10 and the business operator B 11 in advance (751).

The business operator B 11 requests the business operator A 10 to prepare for switching business operators (753). In response, the business operator A 10 authenticates the business operator B 11 (754). Then, when the authentication is successful, the business operator A 10 requests an authentication token for switching business operators from the trust business operator 20 (755). The trust business operator 20 authenticates the business operator A 10 and confirms the contract information (756). As a result, if there is no problem, the switching of the business operators is permitted, and the trust proxy server 200 is requested to generate an authentication token (757).

In response to the request to generate an authentication token, the trust proxy server 200 generates an authentication token (758). The trust business operator 20 transmits the generated authentication token to the business operator A 10 (759).

The business operator A 10 that has received the authentication token transmits a request for a business operator switching preparation for switching to the business operator B 11 together with the authentication token to the trust proxy server 200 (761). The trust proxy server 200 that has received the preparation request of business operator switching confirms the authentication token from the business operator A 10 (762), and if there is no problem, gives permission to change the binding destination of the virtual business operator X to the business operator B 11 (763). The business operator A 10 that has received the permission reports the completion of the preparation for switching business operator to the business operator B 11 (764).

Thereafter, the processes of 743 to 749 in the second example described above are further performed, whereby the binding destination of the virtual business operator X is changed from the business operator A 10 to the business operator B 11.

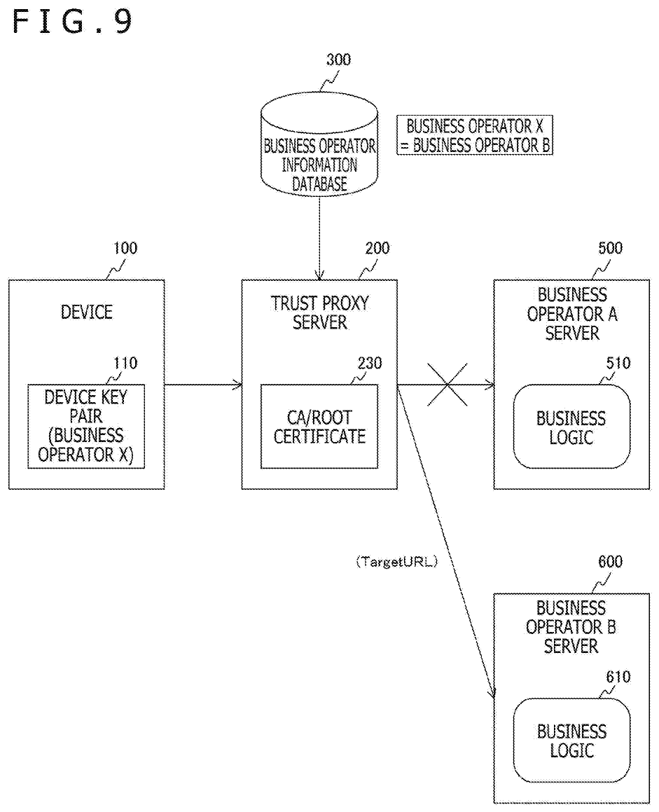

FIG. 9 is a diagram illustrating an example of a state in which the binding destination of the virtual business operator X has been changed from the business operator A to the business operator B in the embodiment of the present technology.

The case is assumed where the information stored in association with the virtual business operator identification information of the virtual business operator X in the business operator information database 300 is changed from the business operator A identification information to the business operator B identification information by the above-described series of sequences. Until that time, the sensing information transmitted from the device 100 has been transmitted to the business operator A server 500, but after the business operator switching is performed, the sensing information is transmitted to a business operator B server 600, and a business logic 610 of the business operator B is performed. That is, the sensing information can be transmitted to the business operator B server 600 of the business operator B after the transfer without updating the device 100 accompanying the transfer.

### <3. Modification>

In the above-described embodiment, the trust proxy server model assumed to use the trust proxy server is employed. On the other hand, the modification adopts a trust client server model in which a device is connected to a business operator server by using a trust client and a trust server provided by a trust business operator.

### [Trust Client Server Model]

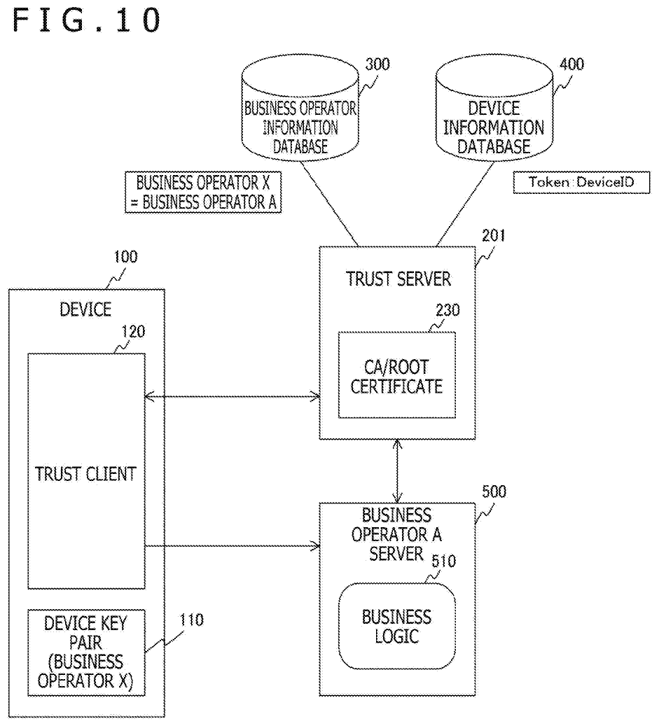

FIG. 10 is a diagram illustrating an example of an overall configuration of a system based on a trust client server model according to the embodiment of the present technology.

The system includes the device 100, a trust server 201, the business operator information database 300, a device information database 400, and the business operator A server 500.

The device 100 transmits the sensing information by wireless communication, similarly to the above embodiment. However, in the modification, the device 100 includes a trust client 120. The trust client 120 accesses the business operator A server 500 by receiving the authentication token and the business operator A identification information from the trust server 201.

The trust server 201 transmits an authentication token and business operator A identification information in response to a request from the trust client 120. Note that the trust server 201 is an example of the information processing apparatus described in the claims.

The device information database 400 is a database that stores the authentication token generated by the trust server 201 in association with the device identifier of the device 100.

### [Operation]

In the trust client server model, first, the trust client 120 requests the trust server 201 to authenticate the device 100. Thereby, the trust server 201 authenticates the device 100, and when the authentication is successful, the trust server 201 makes an inquiry to the business operator information database 300 to identify the business operator A identification information of the actual business operator A bound to the virtual business operator X. Then, the trust server 201 generates an authentication token for an authentication between servers. The generated authentication token is stored in the device information database 400 in association with the device identifier of the device 100. Then, the trust server 201 returns the business operator A identification information and the authentication token to the trust client 120.

The trust client 120 transmits the message together with the authentication token on the basis of the business operator A identification information. That is, if the business operator A identification information is the URL address of the business operator A server 500, the message is transmitted to the business operator A server 500 by using the URL address.

The business operator A server 500 that has received the message transmits the received authentication token to the trust server 201. In response to this, when confirming that the message is transmitted from the authenticated device 100, the trust server 201 transmits the device identifier stored in the device information database 400 in association with the authentication token to the business operator A server 500. Thereby, the business operator A server 500 confirms that the message is one correctly transmitted from the device 100. That is, spoofing can be prevented and expiration of the authentication token can be managed to reduce the risk. Note that the authentication token is an example of authentication success information described in the claims.

### <4. Manufacturing of Device>

In the above-described embodiment, it is assumed that a trust business operator manufactures the device. However, generation of a device key pair and manufacturing of the device do not necessarily have to be performed by the same business operator. Hereinafter, an aspect of device manufacturing will be described.

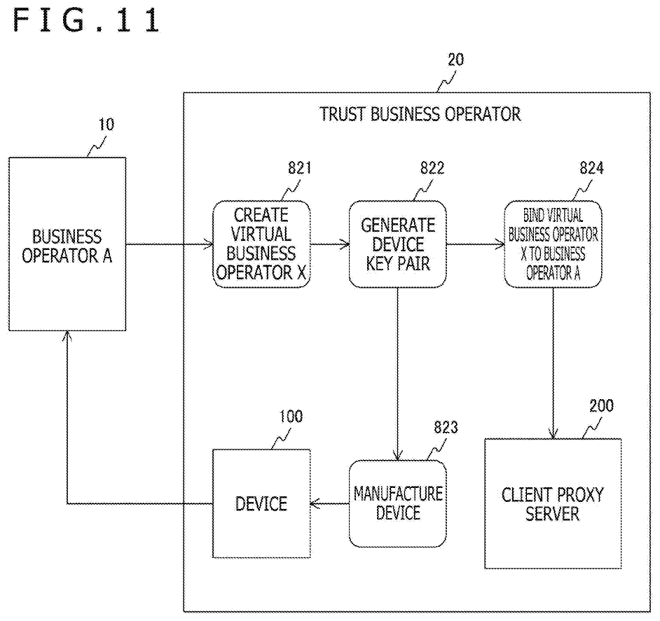

FIG. 11 is a diagram illustrating a first example of a device manufacturing flow according to the embodiment of the present technology.

In such an example, it is assumed that the trust business operator performs both the device manufacturing business and the trust business. In such a case, a person other than the trust business operator does not acquire the device key pair, so that security can be managed safely.

First, the business operator A 10 requests the trust business operator 20 to manufacture the device 100. At this time, the URL address of the business operator A server 500 to which the device 100 finally connects may be registered at the same time.

In response to the device manufacturing request from the business operator A 10, the trust business operator 20 creates the virtual business operator X (821). Then, the trust business operator 20 generates a device key pair of the device 100 (822), and writes the device key pair into the device 100 as the device key pair 110 (823).

Then, the trust business operator 20 performs provisioning for using the device 100 to the trust proxy server 200 (824). In other words, the trust business operator 20 makes provision so as to bind the business operator A to the virtual business operator X, generates a CA/root certificate, and stores the certificate as the CA/root certificate 230. Note that the processes are similar also in the case of the trust server 201 described above.

The device 100 manufactured in such a way is provided to the business operator A 10.

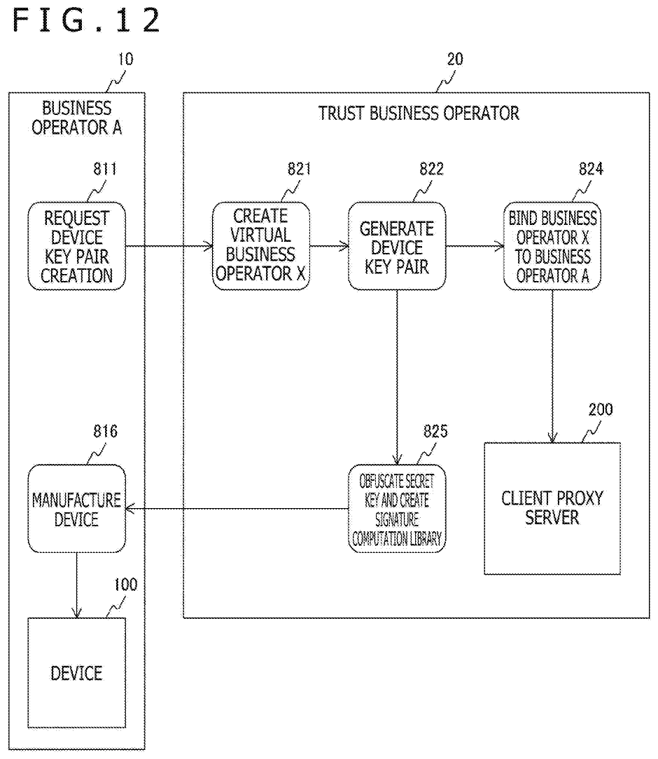

FIG. 12 is a diagram illustrating a second example of the device manufacturing flow according to the embodiment of the present technology.

In such an example, it is assumed that the trust business operator performs up to creation of a device key pair, and the device manufacturing business is performed by the business operator A. In such a case, since the business operator A acquires the device key pair, there is a fear that the device key pair may be used even after the transfer to another business operator. Therefore, when the trust business operator supplies the device key pair to the business operator A, it is necessary to obfuscate the key pair.

First, the business operator A 10 requests the trust business operator 20 to generate a device key (811).

In response to the device manufacturing request from the business operator A 10, the trust business operator 20 creates the virtual business operator X (821). Further, the trust business operator 20 generates a device key pair of the device 100 (822). Then, the trust business operator 20 obfuscates the created secret key and creates a library for signature computation (825). Here, the obfuscated secret key can be used only for signature calculation by the signature computation library. As a result, the device key pair including the public key and the obfuscated secret key, and the signature computation library are supplied to the business operator A 10.

Further, the trust business operator 20 performs provisioning for using the device 100 to the trust proxy server 200 similarly to the first example described above (824).

The business operator A 10 manufactures the device 100 by using the device key pair and the signature computation library supplied from the trust business operator 20 (816). The device key pair and the signature computation library are used as follows when the device 100 is operated.

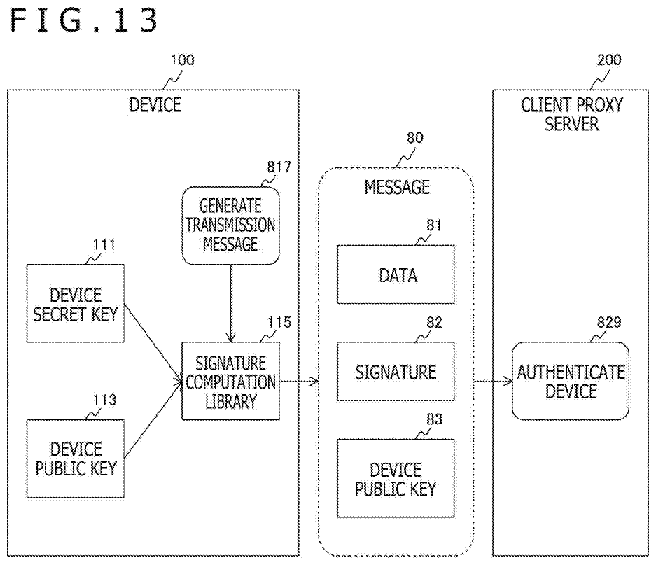

FIG. 13 is a diagram illustrating an example of a message transmitted from the device 100 according to the embodiment of the present technology.

The device 100 stores a device secret key 111 and a device public key 113 as the device key pair 110. Further, the device 100 includes a signature computation library 115. At this time, since the device secret key 111 is stored in the device 100 with the key obfuscated, the business operator A cannot restore the original data. Therefore, the business operator A can be prevented from spoofing the business operator B after the device 100 is transferred to the business operator B.

The device 100 generates a message 80 including the sensing information as data 81 (817). At this time, the signature computation library 115 generates a signature 82 and signs the message 80. Further, the device public key 113 is bundled in the message 80 as a device public key 83.

The trust proxy server 200 authenticates the device 100 by the message 80 thus transmitted (829).

### <5. Revocation of Device>

In the above-described embodiment, although it is assumed that the device 100 is transferred from the business operator A to the business operator B, a case where the business operator A withdraws from the business without a transfer destination may also occur. Here, a case will be described in which the binding of the device 100 to the virtual business operator X is invalidated (revoked).

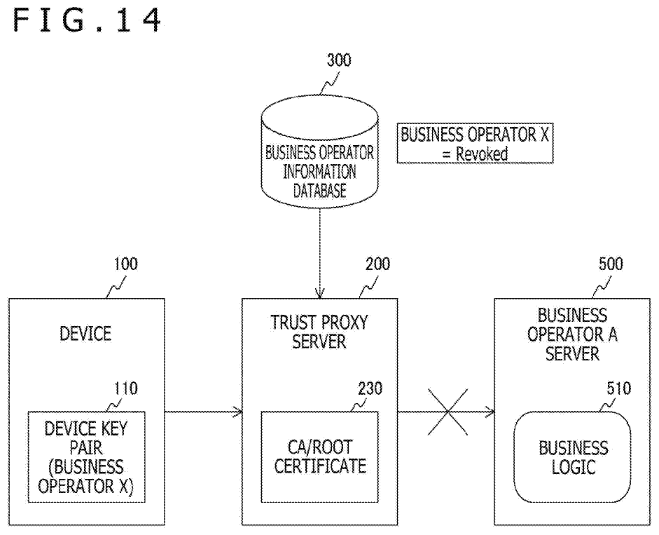

FIG. 14 is a diagram illustrating an example of revoking the binding of the device 100 according to the embodiment of the present technology.

In the business operator information database 300, the business operator bound to the virtual business operator X can be deleted by changing the business operator identification information stored in association with the virtual business operator identification information of the virtual business operator X to information indicating a revoked state such as a revoked flag. Further, revocation may be carried out by issuing a CRL (Certificate Revocation List), or both may be used in combination.

In the case where revocation is performed using a certificate revocation list, refusal can be performed by a certificate verification layer such as TLS (Transport Layer Security). In such a case, the transfer to the business operator A server 500 is not normally performed.

On the other hand, in the case where revocation is performed by the binding of a higher-layer business operator, in other words, in the case where revocation is performed at the discretion of the business operator A without entrusting the trust proxy server 200, the business logic 510 can also be executed in a revoked state.

### <6. Collection of Device>

In the above-described embodiment, although it is assumed that the device 100 is transferred from the business operator A to the business operator B, a case where the business operator A collects the device 100 without transferring the device 100 may also occur. In such a case, the business operator A may request the collection operator C to collect the device instead of collecting by itself, and it is convenient that the binding to the virtual business operator X is temporarily changed into binding to the collection operator C. Here, a case will be described in which the binding of the device 100 to the virtual business operator X is changed into the binding to the collection operator C.

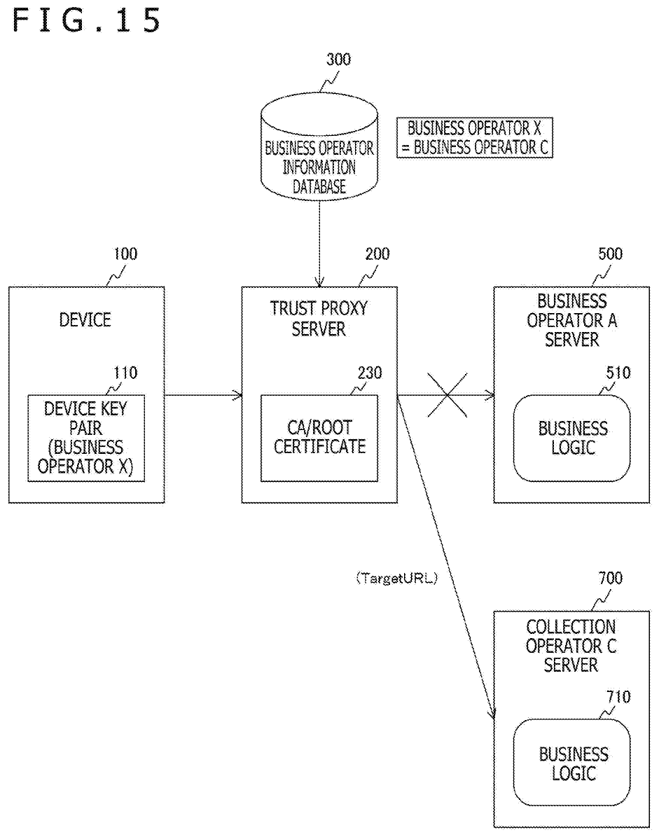

FIG. 15 is a diagram illustrating an example of a case where the binding of the device 100 to the virtual business operator X is changed into binding to the collection operator C in the embodiment of the present technology.

When the device 100 is no longer needed due to the end of the business, device failure, collection or re-installation due to the installation failure, etc., the business operator to which the virtual business operator X is bound is changed from the business operator A to the collection operator C. The operation of the trust proxy server 200 is similar to the change to the business operator B due to the transfer.

The message transmitted from the device 100 is received by a collection operator C server 700 via the trust proxy server 200. The collection operator C, as a business logic 710, identifies the location of the device 100 by using the position information and the like transmitted from the device 100 and collects the device 100. That is, the binding change similar to that at the time of transfer can be used to collect the device 100.

### [Effect]

As described above, according to the embodiment of the present technology, the business operator can be identified by storing the business operator identification information in the business operator information database 300 in association with the virtual business operator identification information. Therefore, even in the case where the business operator of the device 100 is changed, the operation can be continued without updating the device 100.

Note that the above-described embodiment is an example for embodying the present technology, and the matters in the embodiment and matters specifying the invention in the claims have a mutually corresponding relationship. Similarly, the matters specifying the invention in the claims and the matters with the same names as these in the embodiment of the present technology have a mutually corresponding relationship. However, the present technology is not limited to the embodiment, and can be embodied by variously modifying the embodiment without departing from the gist thereof.

Further, the processing procedure described in the above-described embodiment may be regarded as a method having a series of the procedures, and may be regarded as a program for causing a computer to execute the series of procedures or a recording medium storing the program. As the recording medium, for example, a CD (Compact Disc), an MD (MiniDisc), a DVD (Digital Versatile Disc), a memory card, a Blu-ray Disc (registered trademark), and the like can be used.

It should be noted that the effects described in the specification are merely examples, and thus the effect is not limited thereto and may have other effects.

Note that the present technology may also have the following configurations.
(1)

An information processing apparatus including:

a reception unit that receives sensing information addressed to a virtual business operator from a sensing device that measures a surrounding environment; and

an identification unit that makes an inquiry to a storage unit that stores virtual business operator identification information for identifying the virtual business operator and actual business operator identification information for identifying an actual business operator, the virtual business operator identification information and the actual business operator identification information being associated with each other, and that identifies the actual business operator identification information corresponding to the sensing information.
(2)

The information processing apparatus described in the abovementioned item (1), in which

the identification unit transmits the sensing information on the basis of the identified actual business operator identification information.
(3)

The information processing apparatus described in the abovementioned item (1) or (2), further including:

an authentication unit for authenticating the virtual business operator by using key information unique to the sensing device, in which

the reception unit receives the key information together with the sensing information, and

the identification unit transmits the sensing information on the basis of the identified actual business operator identification information in the case where authentication by the authentication unit is successful.
(4)

The information processing apparatus described in the abovementioned item (1), in which

the identification unit transmits the identified actual business operator identification information to the sensing device.
(5)

The information processing apparatus described in the abovementioned item (1) or (4), further including:

an authentication unit for authenticating the virtual business operator by using key information unique to the sensing device, in which

the reception unit receives the key information,

the identification unit transmits the identified actual business operator identification information and authentication success information to the sensing device in the case where the authentication by the authentication unit is successful, and

the authentication unit authenticates the sensing information when receiving the authentication success information together with the sensing information from the sensing device.
(6)

The information processing apparatus described in any one of the abovementioned items (1) to (5), in which

the actual business operator identification information includes a URL address of the actual business operator.
(7)

The information processing apparatus described in any one of the abovementioned items (1) to (6), further including:

a switching unit that changes over from the actual business operator identification information stored in association with the virtual business operator identification information in the storage unit to another business operator identification information for identifying another actual business operator.
(8)

The information processing apparatus described in the abovementioned item (7), in which

the switching unit makes a switch to the another business operator identification information in response to a request from the another business operator.
(9)

The information processing apparatus described in the abovementioned item (7), in which

the switching unit makes a switch to the another business operator identification information in accordance with a cooperation of the actual business operator and the another business operator.
(10)

The information processing apparatus described in the abovementioned item (7), in which

the switching unit changes the actual business operator identification information stored in the storage unit in association with the virtual business operator identification information to make a switch to a revoked state.
(11)

The information processing apparatus described in the abovementioned any one of items (1) to (10) further including the storage unit.
(12)

A processing method of an information processing apparatus including:

a step of receiving sensing information addressed to a virtual business operator from a sensing device that measures a surrounding environment; and

a step of identifying actual business operator identification information corresponding to the sensing information by making an inquiry to a storage unit that stores virtual business operator identification information for identifying the virtual business operator and the actual business operator identification information for identifying an actual business operator, the virtual business operator identification information and the actual business operator identification information being associated with each other.

### REFERENCE SIGNS LIST

10 Business operator A

11 Business operator B

20 Trust business operator

100 Device

110 Device key pair

111 Device secret key

113 Device public key

115 Signature computation library

120 Trust client

200 Trust proxy server

201 Trust server

210 Reception unit

220 Authentication unit

230 CA/root certificate

240 Identification unit

260 Switching unit

300 Business operator information database

400 Device information database

500 Business operator A server

600 Business operator B server

700 Collection operator C server

510, 610, 710 Business logic

1. An information processing apparatus comprising:
a reception unit that receives sensing information addressed to a virtual business operator from a sensing device that measures a surrounding environment; and
an identification unit that makes an inquiry to a storage unit that stores virtual business operator identification information for identifying the virtual business operator and actual business operator identification information for identifying an actual business operator, the virtual business operator identification information and the actual business operator identification information being associated with each other, and that identifies the actual business operator identification information corresponding to the sensing information.

2. The information processing apparatus according to claim 1, wherein
the identification unit transmits the sensing information on a basis of the identified actual business operator identification information.

3. The information processing apparatus according to claim 1, further comprising:
an authentication unit for authenticating the virtual business operator by using key information unique to the sensing device, wherein
the reception unit receives the key information together with the sensing information, and
the identification unit transmits the sensing information on a basis of the identified actual business operator identification information in a case where authentication by the authentication unit is successful.

4. The information processing apparatus according to claim 1, wherein
the identification unit transmits the identified actual business operator identification information to the sensing device.

5. The information processing apparatus according to claim 1, further comprising:
an authentication unit for authenticating the virtual business operator by using key information unique to the sensing device, wherein
the reception unit receives the key information,
the identification unit transmits the identified actual business operator identification information and authentication success information to the sensing device in a case where authentication by the authentication unit is successful, and
the authentication unit authenticates the sensing information when receiving the authentication success information together with the sensing information from the sensing device.

6. The information processing apparatus according to claim 1, wherein
the actual business operator identification information includes a URL address of the actual business operator.

7. The information processing apparatus according to claim 1, further comprising:
a switching unit that changes over from the actual business operator identification information stored in association with the virtual business operator identification information in the storage unit to another business operator identification information for identifying another actual business operator.

8. The information processing apparatus according to claim 7, wherein
the switching unit makes a switch to the another business operator identification information in response to a request from the another business operator.

9. The information processing apparatus according to claim 7, wherein
the switching unit makes a switch to the another business operator identification information in accordance with a cooperation of the actual business operator and the another business operator.

10. The information processing apparatus according to claim 7, wherein
the switching unit changes the actual business operator identification information stored in the storage unit in association with the virtual business operator identification information to make a switch to a revoked state.

11. The information processing apparatus according to claim 1, further comprising the storage unit.

12. A processing method of an information processing apparatus comprising:
a step of receiving sensing information addressed to a virtual business operator from a sensing device that measures a surrounding environment; and
a step of identifying actual business operator identification information corresponding to the sensing information by making an inquiry to a storage unit that stores virtual business operator identification information for identifying the virtual business operator and the actual business operator identification information for identifying an actual business operator, the virtual business operator identification information and the actual business operator identification information being associated with each other.
